(19) United States
(12) Patent Application Publication
(10) Pub. No.: US 2026/0368957 A1
(43) Pub. Date: Nov. 19, 2026

(54) EFFICIENT HUMAN HAIR COLOR AUGMENTATION FOR ENRICHING FACE IMAGE SUPER RESOLUTION DATASET

(71) Applicant: Samsung Electronics Co., Ltd., Suwon-si (KR)

(72) Inventors: Xinyu Guo, Irvine, CA (US); Tien Bau, Irvine, CA (US); Joonsoo Kim, Irvine, CA (US); Sumit Jha, Aliso Viejo, CA (US); Zhe Zhu, Irvine, CA (US)

(21) Appl. No.: 19/669,880

(22) Filed: May 6, 2026

Related U.S. Application Data
(60) Provisional application No. 63/807,440, filed on May 16, 2025.

(51) Int. Cl. G06T 11/10; G06T 3/4053; G06T 7/11; G06T 7/90

(52) U.S. Cl. CPC G06T 11/10; G06T 3/4053; G06T 7/11; G06T 7/90; G06T 2207/10024; G06T 2207/20081; G06T 2207/30201

(57) ABSTRACT

A method includes using at least one processor of an electronic device obtaining a plurality of face inputs and one or more machine-learning (ML) models based on one or more datasets including a plurality of faces with respective hair, preprocessing the face inputs using the ML models to distinguish faces based on the respective hair, obtaining an image frame including a subject having an input hair color, generating a target hair color based on the input hair color, and generating an augmented hair color based on the target hair color by applying a non-learning algorithm and a dictionary data structure to the input hair color.

### CROSS-REFERENCE TO RELATED APPLICATION AND PRIORITY CLAIM

This application claims priority under 35 U.S.C. § 119(e) to U.S. Provisional Patent Application No. 63/807,440 filed on May 16, 2025, which is hereby incorporated by reference in its entirety.

### TECHNICAL FIELD

This disclosure relates generally to image processing systems. More specifically, this disclosure relates to efficient human hair color augmentation for enriching a face image super resolution dataset.

### BACKGROUND

In image processing, human hair color augmentation is an important application in the image synthesis domain, and is widely used to enrich human face datasets. Maintaining a balanced human face dataset with adequate hair color diversity can significantly benefit model training for image super resolution (ISR) models. A well-trained ISR model is capable of generating super resolution (SR) hair details for various hair colors, especially for hair colors that are rarer, such as grey and white, than others, such as black. Thus, a well-designed hair color augmentation system can benefit ISR models by helping produce images featuring high-quality human hair for display on televisions or other digital displays.

### SUMMARY

This disclosure relates to efficient human hair color augmentation for enriching a face image super resolution dataset or other applications.

In a first embodiment, a method includes obtaining, using at least one processor of an electronic device, a plurality of face inputs and one or more machine-learning (ML) models based on one or more datasets comprising a plurality of faces with respective hair. The method also includes preprocessing, using the at least one processor, the face inputs using the ML models to distinguish faces based on the respective hair. The method further includes obtaining, using the at least one processor, an image frame including a subject having an input hair color. The method further includes generating, using the at least one processor, a target hair color based on the input hair color. The method further includes generating, using the at least one processor, an augmented hair color based on the target hair color by applying a non-learning algorithm and a dictionary data structure to the input hair color.

The method can also include extracting the input hair color from the subject of the obtained image frame by dividing the subject into a hair region and a non-hair region and combining the augmented hair color with the non-hair region to generate an augmented image frame. The method can also include blending a plurality of image frames to eliminate edges between the hair region having the augmented hair color and the non-hair region having skin of the subject. The augmented image frame can also be one of the plurality of image frames.

In a second embodiment, an electronic device includes at least one processing device configured to obtain a plurality of face inputs and one or more machine-learning (ML) models based on one or more datasets comprising a plurality of faces with respective hair, preprocess the face inputs using the ML models to distinguish faces based on the respective hair, obtain an image frame including a subject having an input hair color, generate a target hair color based on the input hair color, and generate an augmented hair color based on the target hair color by applying a non-learning algorithm and a dictionary data structure to the input hair color.

In a third embodiment, a non-transitory machine readable medium contains instructions that when executed cause at least one processor of an electronic device to obtain a plurality of face inputs and one or more machine-learning (ML) models based on one or more datasets comprising a plurality of faces with respective hair, preprocess the face inputs using the ML models to distinguish faces based on the respective hair, obtain an image frame including a subject having an input hair color, generate a target hair color based on the input hair color, and generate an augmented hair color based on the target hair color by applying a non-learning algorithm and a dictionary data structure to the input hair color.

Any one or any combination of the following features may be used with the first, second, or third embodiment. The target hair color can be an appropriate hair color that is provided as one of one or more candidate colors to improve visual quality of the input hair color. Preprocessing can include generating one or more categories of hair color based on the one or more datasets and training the one or more ML models based on the categories. The target hair color can be generated by categorizing the input hair color based on the one or more categories and applying the ML model that corresponds to the categorized input hair color. Categorizing the input hair color can include excluding the at least one filtered hair color in at least one category and clustering unexcluded hair colors into at least one other category.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resonance angiography (MRA) device, a magnetic resonance imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2A illustrates an example first stage of a process for hair color augmentation and FIG. 2B illustrates an example second stage of the process for hair color augmentation in accordance with this disclosure;

FIG. 3 illustrates an example process for hair color augmentation in accordance with this disclosure;

FIG. 4 illustrates an example process for generating a hair mask and hair color in accordance with this disclosure;

FIG. 5 illustrates an example process for hair color category clustering in accordance with this disclosure; and

FIG. 6 illustrates an example method for efficient human hair color augmentation for enriching a face image SR dataset in accordance with this disclosure.

### DETAILED DESCRIPTION

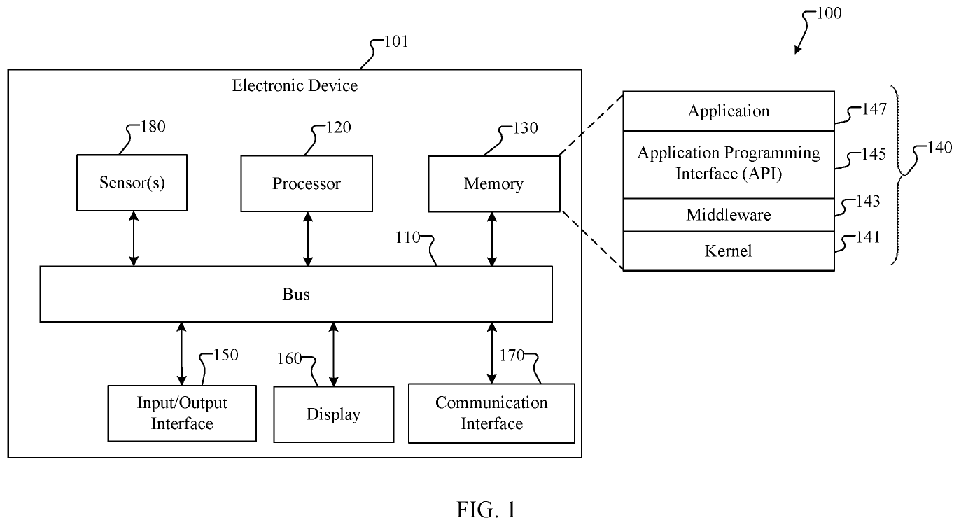

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, in image processing, human hair color augmentation is an important application in the image synthesis domain, and is widely used to enrich human face datasets. Maintaining a balanced human face dataset with adequate hair color diversity can significantly benefit model training for image super resolution (ISR) models. A well-trained ISR model is capable of generating super resolution (SR) hair details for various hair colors, especially for hair colors that are rarer, such as grey and white, than others, such as black. Thus, a well-designed hair color augmentation system can benefit ISR models by helping produce images featuring high-quality human hair for display on televisions or other digital displays, including high definition (HD) displays.

Deep learning (DL)-based hair color augmentation methods exist in the art, including Generative Adversarial Networks (GANs) and diffusion-based methods. Unfortunately, these DL-based hair color augmentation methods suffer from a number of problems, including, but not limited to, low efficiency, long research and development (R&D) procedures, inconsistent performance, and slow adaption to the new dataset.

Existing DL-based hair color augmentation methods have issues with low efficiency. Execution speed of DL-based hair color augmentation methods is generally slow, even when performed on a machine that features GPUs. An inefficient color augmentation algorithm significantly prolongs ISR training procedures when integrated into ISR model training pipelines. DL-based hair color augmentation methods are not suitable for online augmentation (OA) in which color augmentation is conducted during or contemporaneously with ISR model training. OA may be preferable because OA implicitly enriches a training dataset without increasing the actual size of the dataset in storage, such as memory.

Existing DL-based hair color augmentation methods also have issues with long R&D procedures. Tuning DL architecture, hyper-parameters, and validating DL using multiple different datasets requires a heavy time budget. This frequently delays downstream tasks, such as ISR model training.

Existing DL-based hair color augmentation methods also have issues with inconsistent performance. DL-based hair color augmentation methods tend to produce acceptable augmentations for common hair colors. However, DL-based hair color augmentation methods generally do not produce acceptable augmentations for hair colors in the dataset that are rarer, such as grey or white. Hair colors of subjects in face datasets generally follow a Gaussian distribution, meaning they are imbalanced. The performance of DL-based hair color augmentation methods trained by such datasets is therefore often inconsistent with respect to different hair colors.

Existing DL-based hair color augmentation methods also have issues with slow adaption to the new dataset. DL-based hair color augmentation methods usually do not generalize well on data that is not included in the training dataset. Therefore, re-training or fine-tuning the underlying model may be required for each new dataset. This is a bottleneck that often prevents fast development and deployment of DL-based hair color augmentation methods with respect to ISR training pipelines.

There is, therefore, a need to remedy the above-noted problems for online hair color augmentation. This disclosure provides a solution to the above-noted problems, in the form of systems and methods for online hair color augmentation that are efficient, dataset agnostic, and capable of generating consistent, adequate results. Additionally, the systems and methods disclosed herein are configured to be efficiently integrated into ISR training pipelines.

In some embodiments, the disclosed technology can include, but is not limited to providing SR human hair color augmentation that can be applied during an online process, consistently generating high-fidelity SR human hair color augmentations, and fast adaptation to any human face datasets.

This disclosure also allows for providing SR human hair color augmentation that can be applied during an online process. Advantageously, this disclosure solves the problems above with respect to low efficiency and long R&D procedures.

For example, rather than building deep neural networks (DNNs) with millions of parameters, the disclosed technology provides systems and methods that use (e.g., only use) light-weight algorithms and simple data structures. Machine learning (ML) algorithms can be applied, such as K-Means and Gaussian Mixture Model (GMM) and/or image processing algorithms, such as color scale, Laplacian pyramids, and contrast limited adaptive histogram equalization (CLAHE). The ML algorithms and/or image processing algorithms may employ one or more simple data structures, such as a dictionary. Compared to DL methods, these algorithms contain far fewer parameters, which allows them to provide improved efficiency and faster optimization.

This disclosure also allows for consistently generating high-fidelity SR human hair color augmentations. Advantageously, the disclosed technology solves the problem above with respect to inconsistent performance.

For example, the disclosed technology can provide consistently high performance for color augmentation. A color augmentation module can be designed, that provides good results with certain color categories. A target color generation module can be applied to generate a proper target color for the input hair color based on a color category of the input hair color. An image blending module can be applied to eliminate edges around the augmented hair to provide a more natural appearance when displayed. The three modules can harmoniously ensure that color augmentation occurs for desired color categories, and can produce human faces with augmented hair color that appears natural and realistic.

This disclosure also allows for fast adaptation to any human face dataset. Advantageously, the disclosed technology solves the problem above with respect to slow adaption to a new dataset.

For example, for DL methods, color augmentation may require re-training or fine-tuning of the DL models with numerous parameters before they are applied to new or different datasets. This disclosure provides a preprocessing module that is configured to obtain all inputs and/or ML models required for augmentation based on the face dataset before applying the color augmentation pipeline. This preprocessing can be dataset agnostic, and require less processing time than would be required for traditional training and/or fine-tuning of DNNs.

The ability to consistently generate decent or acceptable color augmentation is important for systems that employ color augmentation. As described above with respect to inconsistent performance, DL methods tend to generate un-satisfactory augmentation results for rare hair color(s), such as grey or white, when training dataset(s). In accordance with this disclosure and as shown and described below, a target color generation module, a color augmentation module, and an image blending module cooperate to solve this issue. For example, the color augmentation module can conduct hair color augmentation, changing or modifying hair color from an input or original color to a target color. More specifically, an average or mean RGB color of the input hair can be calculated by averaging pixel RGB values over all of the subject's hair, then a residual can be calculated between the mean RBG color and the target RGB color. The residual color can then be added to the original hair RGB pixels. Finally, contrast of the hair color augmented image can be adjusted. In some instances, the quality of the hair color augmentation may not be guaranteed merely by applying this color augmentation module. Accordingly, in such instances, decent or acceptable hair color augmentation may occur only between certain color categories. For example, an augmentation operation from blond to grey or white may provide decent or acceptable results, but satisfactory results may not be consistently realized when attempting to augment black hair, regardless of a target color category. To alleviate these problems resulting from being forced to select target colors that may provide unacceptable results for certain input hair colors, a target hair color generation module can be provided. Thus, the target hair color generation module can be used in accordance with this disclosure to select an appropriate target hair color, given an input hair color. The target hair color generation module can employ a group of Gaussian Mixture Models (GMMs) that may be trained according to a particular predefined quantity of color categories. For example, the GMMs may be individually or collectively trained according to one of five predefined color categories. An index can be used to map an input hair color category to the particular GMM(s) to generate the target hair color(s). In some embodiments described herein, hair color augmentation can be guaranteed between safe color categories and/or color category mappings. This may ensure that a hair color augmentation operation results in a high quality hair color augmentation. An image blending module can be used to greatly reduce or eliminate edges around a hair portion of a subject in an augmented image, thereby causing the augmented image to appear more natural and realistic.

To solve the problems regarding low efficiency and long R&D procedure, the disclosed technology provides efficient, light-weight hair color augmentation systems and methods that perform image processing using ML algorithms that employ a small quantity of parameters in each building block. Compared to DL methods, less time is used for architecture and/or parameter tuning and performance validation for different datasets. Further, online execution speed can be about thirteen times faster than DL methods without sacrificing augmentation performance. For example, DL methods may require about two seconds per image for color augmentation, while the systems and methods described herein may require about 0.15 seconds per image.

Displaying images with SR human faces that exhibit a satisfactory or desirable visual quality can be important in various digital imaging display technologies, such as for 4 k and/or 8 k television displays. In some cases, various ISR models are trained, which are each capable of generating high-fidelity SR face images with enriched details from a low-resolution format. Some image datasets of faces may be imbalanced with regard to hair color distribution in the respective images. For example, in a particular dataset, a quantity of images of faces with white and/or grey hair is often lower than a quantity of images of faces with blond, brown, and black hair. In order to improve ISR face model training, image datasets of faces can be balanced by performing hair color augmentation on images in the respective dataset to generate a more even distribution of hair colors in the dataset.

The technology disclosed herein includes an efficient, light-weight hair color augmentation pipeline for image processing that can be integrated into any ISR face model training pipeline. The technology disclosed herein can be performed in an online data augmentation stage in which more rare hair colors can be generated. Compared to existing DL methods which dominate hair color augmentation currently, the technology disclosed herein can efficiently generate high-quality, consistent results and can be quickly adapted to any face dataset

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to human hair color augmentation for enriching a face image dataset or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform human hair color augmentation for enriching a face image dataset. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device, a second electronic device, or a server). For example, the communication interface 170 can be connected with a network through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device or the second external electronic device can be a wearable device or an electronic device-mountable wearable device (such as an HMD). In those other embodiments, when the electronic device 101 is mounted in another electronic device (such as the HMD), the electronic device 101 can communicate with the electronic device through the communication interface 170. The electronic device 101 can be directly connected with another electronic device to communicate with the other electronic device without involving a separate network.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

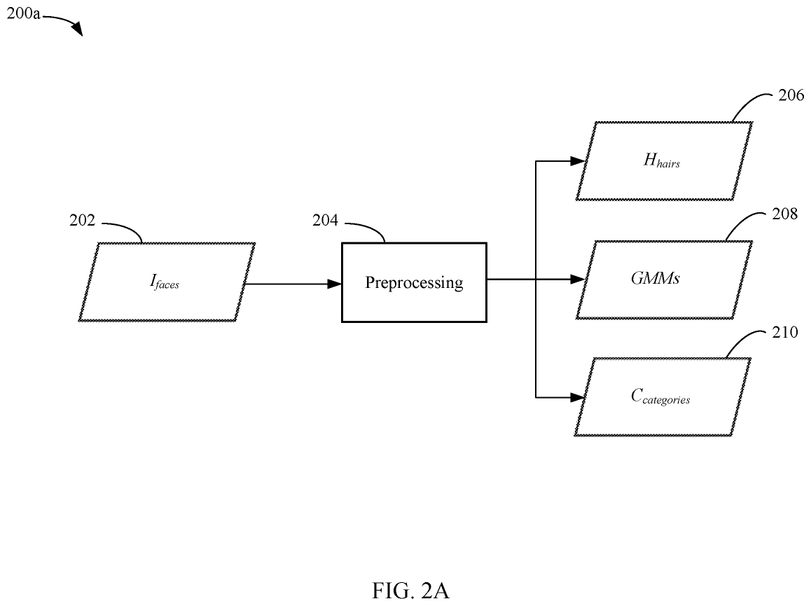

FIG. 2A illustrates an example first stage 200a of a process for hair color augmentation and FIG. 2B illustrates an example second stage 200b of the process for hair color augmentation in accordance with this disclosure. For ease of explanation, the process with the first stage 200a and second stage 200b shown in FIGS. 2A-2B are described as being performed using the electronic device 101 shown in FIG. 1. However, the process shown in FIGS. 2A-2B may be performed using any other suitable device(s) (such as the server 106) and in any other suitable system(s).

As noted above, in some cases, one or more SR human face datasets can be applied during training of an ISR model to improve its performance. DL methods usually do not generalize to an acceptable degree for new datasets. To remedy this issue, re-training and/or fine-tuning may be required for the ISR model before it may be used. This is described above with respect to the problem of slow adaption to a new dataset. In order to address this problem by providing the preprocessing module illustrated in FIG. 2A.

As shown in FIG. 2A, the first stage 200a of the process for hair color augmentation includes a preprocessing operation 204, which generally operates to preprocess image frames of a dataset I_{faces} 202. For example, the preprocessing operation 204 can be performed by the processor 120 to obtain the dataset I_{faces} 202 from memory, such as the memory 130, and preprocess the individual image frames in the dataset I_{faces} 202. The preprocessing operation 204 can apply a well pretrained face segmentation model to get the hair segmentation mask, which may produce a dataset Hₕₐᵢᵣₛ 206 for hair from each image frame. The preprocessing operation 204 may also cluster all image frames into a predefined number of color categories C_{categories} 210, which may be five categories in some embodiments. Examples of the predefined number of color categories C_{categories} 210 can include dark brown and/or red, brown, light brown, blond, and white/grey, based on hair color of a subject in each of the image frames. The preprocessing operation 204 may also train a one or more GMMs 208 to generate target colors for each of the color categories C_{categories} 210.

Hₕₐᵢᵣₛ 206, GMMs 208, and C_{categories} 210 are generated as outputs of preprocessing operation 204. Hₕₐᵢᵣₛ 206 represents hair segmentations of I_{faces}. GMMs 208 represents GMMs generating colors in the number of predefined categories. C_{categories} 210 represents the color categories of I_{faces}. In some embodiments, a pretrained hair segmentation model can be applied to generate the hair segmentation mask Hₕₐᵢᵣₛ (e.g., such as a well-trained model configured for such operation). For each image frame including a face in I_{faces}, an average or mean hair color Cₘₑₐₙ can be calculated by averaging RGB values of pixels in Hₕₐᵢᵣ, which represents hair color in the respective image frame. A K-Means algorithm can be applied to cluster all Cₘₑₐₙs into the predefined number of color categories, such as five categories corresponding to: dark brown and/or red, brown, light brown, blond, and white/grey. Then, the GMMs 208 can be trained to generate colors in for each of the predefined categories C_{categories} 210.

For example, where C_{categories} 210 includes five categories, C_{grey/whties}, C_{blonds}, C_{dark_browns}, C_{light} browns and C_{browns}, five GMMs 208 can be respectively trained. The trained GMMs 208 can then be used to generate RGB colors belonging to the five categories. Generating target colors by applying GMMs 208 can provide several advantages. First, each GMM of the GMMs 208 can be configured to output a group of similar colors, with minimal or no overlap between color groups. Thus, each GMM can generate a distinct, proper target color for a certain hair color category to guarantee a good visual quality of a color transfer operation, as described with respect to FIG. 2B in the second stage. Second, each GMM can be relatively easy to train and to deploy, which significantly saves or conserves resources, such as with respect to R&D.

As shown in FIG. 2B, the second stage 200b of the process for hair color augmentation includes a hair extraction operation 216, a target color generation operation 222, a color augmentation operation 226, a combination operation 232, and a blending operation 236. Each of these operations may be performed by the processor 120 according to instructions stored in the memory 130, such as an application 147. The hair extraction operation 216 can be applied to image frames to extract hair from non-hair within the frame. For example, the hair extraction operation 216 can divide an original SR image frame I_{face} 214 with a subject human face into two parts: hair Iₕₐᵢᵣ 218 and non-hair I_{not_hair} 230, which may include a subject's face, clothing, background, or other parts of the image frame that are not hair. The hair extraction operation 216 can accomplish this division by applying a hair segmentation mask Hₕₐᵢᵣ 212, which may include face attribute labels with associated coordinates that distinguish portions of a subject human's face and body, such as eyes, ears, nose, mouth, forehead, cheeks, chin, neck, shoulders or other portions of the subject human from hair, such as hair growing from the top of the subject's head, mustache, sideburns, beard, eyebrows, eyelashes, and/or other hair.

The target color generation operation 222 can generate a target color for hair augmentation based on one or more hair color categories that can be used to augment hair color of hair Iₕₐᵢᵣ 218 extracted from a subject of an image frame I_{face} 214. For example, a color category C_{category} 220, such as one of the color categories C_{categories} 210, can be used as an input to the target color generation operation 222, which can generate an output target hair color C_{target} 224, which may be formatted in RGB. The color category C_{category} 220 can be selected and correspond to a color category of the extracted hair Iₕₐᵢᵣ 218. The target color generation operation 222 can first employ an input color category to target color mapping function, which selects an appropriate color category for the input color category C_{category} 220 based on a determined hair color of the extracted hair Iₕₐᵢᵣ 218, and then applies a respective GMM, such as one of GMMs 208, to generate the target hair color C_{target} 224.

The color augmentation operation 226 can augment a hair color of the extracted hair Iₕₐᵢᵣ 218 based on the target hair color C_{target} 224. For example, the color augmentation operation 226 can conduct hair color augmentation of the extracted hair Iₕₐᵢᵣ 218 to the target hair color C_{target} 224 by shifting the color of Iₕₐᵢᵣ 218 according to C_{target} 224 to generate an augmented hair color I_{new_hair} 228.

The combination operation 232 can combine the augmented hair color I_{new_hair} 228 and the non-hair I_{not_hair} 230, to generate an updated human face with color augmented hair image frame I_{hair_augment} 234.

The dilation operation 238 can dilate the hair segmentation mask Hₕₐᵢᵣ 212 to generate a dilated hair segmentation mask that can be used by a blending operation 236. For example, the dilation operation 238 can be a morphological operation that dilates, such as by expanding or thickening, the hair segmentation mask Hₕₐᵢᵣ 212 which can allow hair in the image frame to be more prominent and easier for the blending operation 236 to identify, analyze, and manipulate.

The blending operation 236 can blend the original image frame I_{face} 214, which is an SR human face image including hair, and the color augmented hair image frame I_{hair_augment} 234 using the dilated hair segmentation mask from the dilation operation 238. For example, in many instances, the color augmented hair image frame I_{hair_augment} 234 may not appear realistic or have an adequate visual appeal because edges may exist around the hair after the combination operation 232 has been applied. Therefore, the blending operation 236 can use the color augmented hair image frame I_{hair_augment} 234, the original image frame I_{face} 214, and the dilated hair segmentation mask from the dilation operation 238 to blend the two image frames I_{hair_augment} 234 and I_{face} 214 by applying Laplacian pyramids (e.g., can be any effective image blending algorithm) based on the dilated hair mask. The blending operation 236 can output an augmented frame I_{face}_new_hair 240 that appears realistic and has reduced or removed hair edges, as compared to the color augmented hair image frame I_{hair_augment} 234.

Although FIGS. 2A-2B illustrate first and second stages 200a, 200b respectively of one example of a process for hair color augmentation, various changes may be made to FIGS. 2A-2B. For example, various operations or functions in FIGS. 2A-2B may be combined, further subdivided, replicated, omitted, or rearranged and additional components or functions may be added according to particular needs.

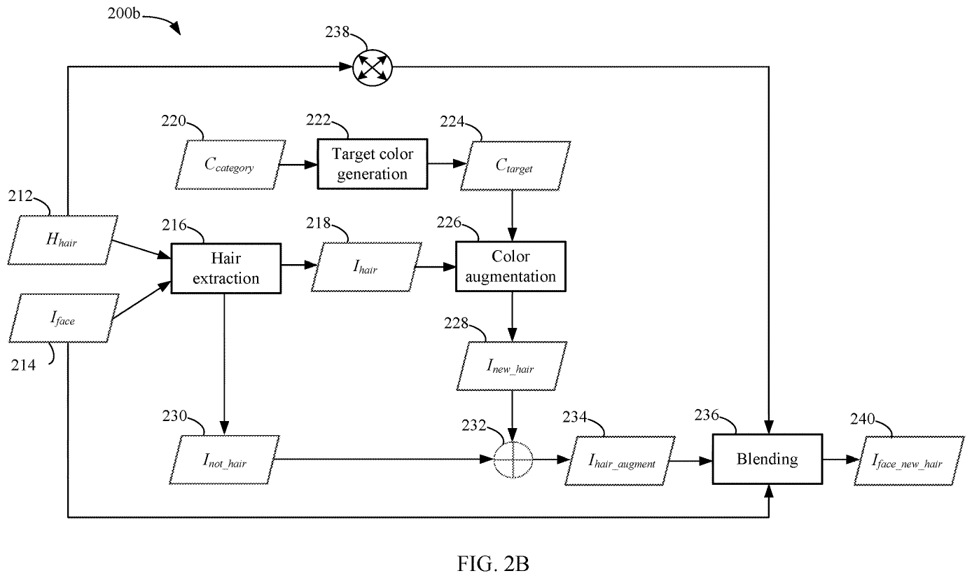

FIG. 3 illustrates an example process 300 for hair color augmentation in accordance with this disclosure. For ease of explanation, the process 300 is described as being performed using the electronic device 101 shown in FIG. 1 and with respect to the first stage 200a and second stage 200b shown in FIGS. 2A-2B. However, the process shown in FIG. 3 may be performed using any other suitable device(s) (such as the server 106) and in any other suitable system(s).

In some embodiments, the disclosed technology can include, but is not limited to providing SR human hair color augmentation that can be applied during an online process, consistently generating high-fidelity SR human hair color augmentations, and fast adaptation to any human face datasets.

As shown in FIG. 3, the process 300 can include the preprocessing operation 204 and hair extraction operation 216, as described previously.

Selecting a target color for a hair color augmentation operation cannot be arbitrarily performed because arbitrary selection can lead to unsatisfactory hair color augmentation. Accordingly, the target color generation operation 222 can apply color category mapping to generate a target color based on a color category of an input hair color. This can ensure the color augmentation operation 226 is high quality based on beneficial mappings between certain color categories. In some embodiments, color category matches can be selectively mapped using a dictionary. Below is an example of a dictionary for color category matches using selective mapping:

```
input-target color category mapping{
  ‘blond’ :[(‘grey/white’, 0.8), (‘light brown’,0.2)],
  ‘light brown’ :[(‘grey/white, 0.6),(‘blond’,0.4)],
  ‘dark brown’ :[(‘blond’,0.5),(‘light brown’, 0.5)],
  ‘grey/white’ :[(‘dark brown’,0.5),(‘light brown’,0.5)]
}
```

In the above dictionary, the input hair color category can be key, where an input hair color category value can be a list applied to a pair of tuples. Each tuple contains a target color category for the input hair color category, and a probability of selecting the target color category. For example, for an input target color category of blond, target color categories may only be grey and/or white with 0.8 probability and light brown with 0.2 probability, according to: ‘blond’:[(‘grey/white’, 0.8), (‘light brown’,0.2)]. Based on this definition, a relative or respective trained GMM can be selected to generate the target color in the target color category. The dictionary may be stored in the memory 130.

In some embodiments, the target color generation operation 222 can include two steps. A first step can include obtaining C_{category} 220 as an input, selecting a target color category based on category candidates with probabilities defined in the source-target color mapping as described above. Second, based on the selected color category, a relative or respective GMM can be selected, such as one of the GMMs 208, to generate C_{target} 224. The GMM may be stored in the memory 130.

In some embodiments, the color augmentation operation can include the following steps: First, hair Iₕₐᵢᵣ 218 and C_{target} 224 can be obtained as inputs, and a mean RGB hair color C_{source} can be calculated for the hair Iₕₐᵢᵣ 218 by averaging RGB values of pixels of the hair Iₕₐᵢᵣ 218. Next, an RGB color residual C_{residual} can be calculated, which can be a difference between C_{target} 224 and C_{source}, according to C_{residual}=C_{target}−C_{source}.

In some embodiments, if C_{residual} were to be added directly to Iₕₐᵢᵣ 218, a large number of pixels may qualify as overflow with values >255, where qualifying as underflow may be values <0. This can lead to unsatisfactory augmentation, such as over exposure of hair color. To avoid this, Iₕₐᵢᵣ 218 can be scaled by multiplying Iₕₐᵢᵣ 218 by a small constant value a to squeeze RGB values. Accordingly, each RGB pixel value in Iₕₐᵢᵣ 218 can be scaled to I_{hair_scale} by a, according to I_{hair_scale}=α*Iₕₐᵢᵣ, where 0<α<1. For example, in some embodiments, selecting α=0.6 can produce satisfactory results for Iₕₐᵢᵣ scale. Other selections for a may be used in other embodiments.

Then, C_{residual} can be added to Iₕₐᵢᵣ scale, and the RGB values can be clipped to a range, such as [0, 255], to generate color augmented hair I_{haircolor_shift}. In some instances, contrast of I_{haircolor_shift} may be low in general as a result of RGB values scaling according to I_{hair_scale}=α*Iₕₐᵢᵣ, as described above. In such cases, a Contrast Limited Adaptive Histogram Equalization (CLAHE) can be applied, for example by the processor 120, to the augmentation's LAB space to improve the contrast of the image. CLAHE differs from ordinary histogram equalization in that CLAHE calculates multiple histograms, each of which corresponds to a separate section of the subject image, and uses the histograms to redistribute brightness values of the image. Application of CLAHE can therefore improve local contrast and enhance high-frequency details in each region of the subject image, thereby causing the color augmentation to appear more natural and realistic than otherwise possible. Thus, CLAHE in LAB color space can be applied to I_{haircolor_shift} to improve local contrast and generate a final augmented hair I_{hair_augment} 234. CLAHE can be an example of a non-learning algorithm in some embodiments.

The blending operation 236 can be applied to improve visual quality of the image after color augmentation of the hair. For example, the blending operation 236 can be applied by the processor 120. As noted above, augmented hair may not appear natural in the updated human face with color augmented hair image frame I_{hair_augment} 234, after I_{not_hair} 230 and I_{new_hair} 228 are combined at the combination operation 232 because edges may be visually apparent between the hair with augmented color and the skin of the subject. In such instances, Laplacian pyramids can be used by blending operation 236 to blend I_{face} 214 and I_{hair_augment} 234 with dilated hair from dilation operation 238. Laplacian Pyramids use a multi-level approach to blend images by creating layers of images with varying resolutions. Each layer represents a band of frequencies, and the blending is done level by level which results in smooth transitions.

Although FIG. 3 illustrates a process 300 for hair color augmentation, various changes may be made to FIG. 3. For example, various operations or functions in FIG. 3 may be combined, further subdivided, replicated, omitted, or rearranged and additional components or functions may be added according to particular needs.

Fast adaptation to any human face dataset—In some embodiments, the technology disclosed herein can provide fast adaptation to any human face dataset. In contrast to and as an improvement over DL methods, algorithms may not require excessive adjustment time to adapt to a new dataset. Accordingly, the preprocessing operation 204 can prepare three different facets prior to application of a hair color augmentation pipeline. First, a hair mask for each subject human face in images of a dataset; second, a hair color category for each subject human's hair; and third, GMMs for generating a target hair RGB color in the predefined color categories.

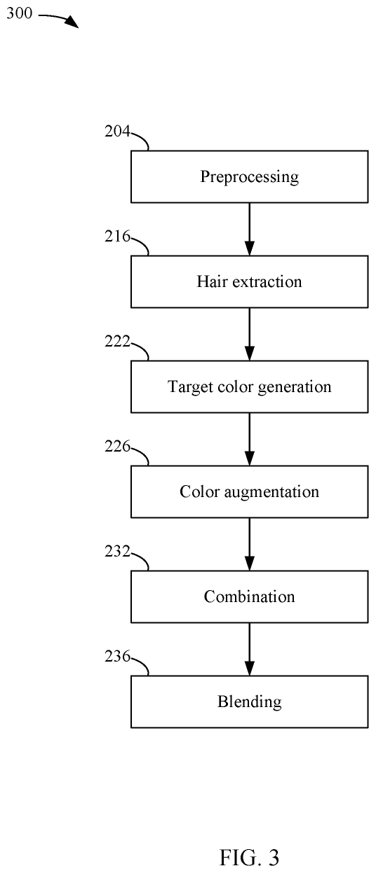

FIG. 4 illustrates an example process 400 for generating a hair mask and hair color in accordance with this disclosure. For ease of explanation, the process 400 is described as being performed using the electronic device 101 shown in FIG. 1 and with respect to the first stage 200a shown in FIG. 2A and the process of FIG. 3. However, the process shown in FIG. 4 may be performed using any other suitable device(s) (such as the server 106) and in any other suitable system(s).

As shown in FIG. 4, for a human face in an original SR image frame I_{face} 214, a human face segmentation operation 402 can include the processor 120 applying a pretrained segmentation model to accurately segment the respective human face in the image frame I_{face} 214 into several parts including the a hair mask I_{hair_mask} 404 and other parts of the face, such as a nose, eyes, ears, cheeks, and other human facial features, and save the hair mask I_{hair_mask} 404 for future use. A mean hair color calculation operation 406 can determine an average RGB value of hair pixel values based on application of the hair mask I_{hair_mask} 404 to the image frame I_{face} 214 to generate a mean hair color C_{rgb} 408. The value of the mean hair color C_{rgb} 408 can represent an average or general hair color of the subject of the image frame I_{face} 214. When each mean hair color C_{rgb} 408 has been calculated, they can be assigned to one of a plurality of predefined color categories, such as five color categories including dark brown and/or red, brown, light brown, blond, and white and/or grey

Although FIG. 4 illustrates a process 400 for generating a hair mask and hair color, various changes may be made to FIG. 4. For example, various operations or functions in FIG. 4 may be combined, further subdivided, replicated, omitted, or rearranged and additional components or functions may be added according to particular needs.

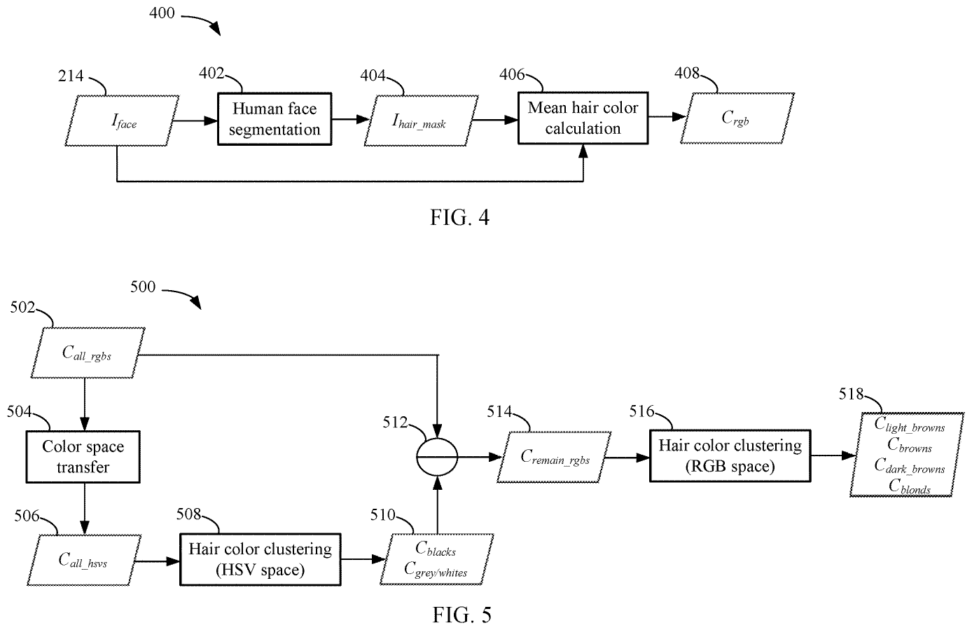

FIG. 5 illustrates an example process 500 for hair color category clustering in accordance with this disclosure. For ease of explanation, the process 500 is described as being performed using the electronic device 101 shown in FIG. 1 and with respect to the FIGS. 2A-4. However, the process shown in FIG. 5 may be performed using any other suitable device(s) (such as the server 106) and in any other suitable system(s).

As shown in FIG. 5, all hair colors in an RGB space can be defined as C_{all_rgbs} 502. Next, a color space transfer operation 504 can be applied by the processor 120, whereby all hair colors C_{all_rgbs} 502 in the RGB space can be transferred and result in all colors C_{all_hsvs} 506 in a hue, saturation, and value (HSV) color space. Because black and grey and/or white are easily identified, a first hair color clustering operation 508 in the HSV color space can be applied to separate out such colors. For example, the first hair color clustering operation 508 can apply a first value threshold, such as V≤0.25, to filter out all black hair C_{blacks}, and a second value threshold can be applied, such as S≤0.15, V≥0.375, to obtain all grey/white hair C_{grey/whites}, collectively C_{blacks}, C_{grey/whites} 510. An exclusion operation 512 can exclude the C_{blacks}, C_{grey/whites} 510 from C_{all_rgbs} 502, which can result in remaining hair colors C_{remain_rgbs} 514. A second hair color clustering operation 516 in the RGB color space can be applied to the C_{remain_rgbs} 514 using, for example, a K-Means algorithm, which may be stored in the memory 130, to cluster the remaining hair colors into hair categories, such as four categories-dark brown and/or red C_{dark_browns}, brown C_{browns}, light brown C_{light_browns}, and blond C_{blond}, collectively C_{dark_browns}, C_{browns}, C_{light} browns, and C_{blond} 518. In some embodiments, Euclidean distance can be used as a similarity metric for the K-Means algorithm.

Efficiently producing SR human hair color augmentation while online, with fast development—In some embodiments, the technology disclosed herein can efficiently produce SR human hair color augmentation while online, and can quickly develop such color augmentation by applying one or more light-weight but effective image processing, ML algorithms. These ML algorithms, which may be stored in the memory 130 and executed by the processor 120, may contain far fewer parameters and hyper-parameters than would otherwise be employed using DL methods. Accordingly, these ML algorithms may be quickly optimized to achieve globally optimized results. For example, when training GMMs and K-means algorithms, a limited amount of time may be dedicated to exploring the number of GMMs and clusters to determine a best fit for a dataset of images including faces. When training GMMs, one or more experiments may be set up and performed to generate a grid search to determine a number of GMMs, such as from two to twenty. For each experiment, Bayesian information criterion and Akaike Information Criterion (AIC) can be employed to evaluate performance. Processing may require several minutes, such as three minutes, for a dataset containing about 30,000 face images. A similar amount of time can be used to optimize K-Means algorithms to determine color categories. In CLAHE, a quantity of parameters, such as two parameters including ClipLimit and tileGridSize, can be tuned to cause appropriate functionality. For color scaling and a Laplacian pyramid, a single parameter, such as scale a of color scaling, can be tuned according to the number of pyramids of the Laplacian pyramid. Due to fewer parameters requiring tuning compared to existing DL methods, R&D development time requirements are far lower than would be required for such DL methods, which may require hours or even days. Additionally, execution time for image processing pipelines can be efficient enough (e.g., on the order of about 0.15 secs/image) to perform online color augmentation. Due to this advantage, the color augmentation techniques described herein can be integrated with any ISR model training pipeline. Color scaling and Laplacian pyramids can be examples of non-learning algorithms in some embodiments.

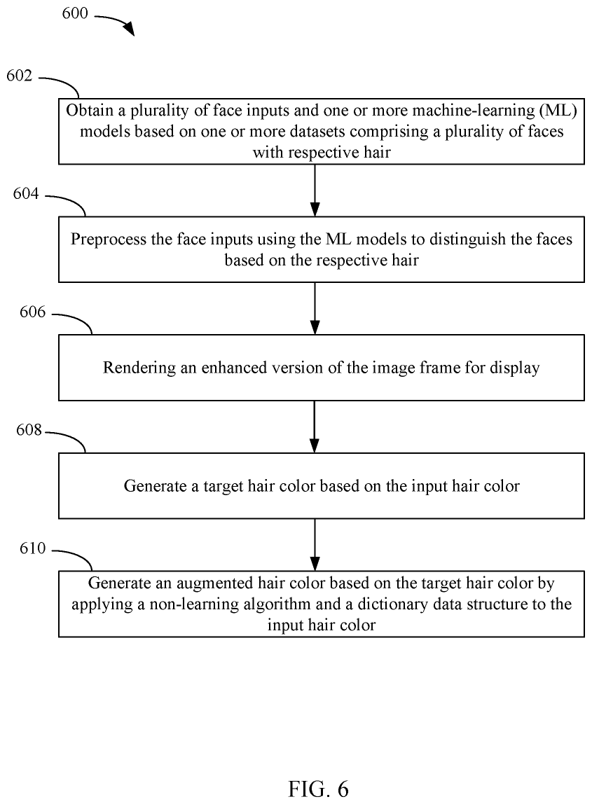

FIG. 6 illustrates an example method 600 for efficient human hair color augmentation for enriching a face image SR dataset in accordance with this disclosure. For ease of explanation, the method 600 shown in FIG. 6 is described as being performed using the electronic device 101 shown in FIG. 1. However, the method 600 shown in FIG. 6 may be performed using any other suitable device(s) (such as the server 106) and in any other suitable system(s).

As shown in FIG. 6, the method 600 can include obtaining a plurality of face inputs and one or more machine-learning (ML) models based on one or more datasets comprising a plurality of faces with respective hair at block 602. This may include, for example, the at least one processor 120 of the electronic device 101 performing the preprocessing operation 204 obtain a dataset, such as the dataset I_{faces} 202, from memory, such as the memory 130.

At block 604, the face inputs can be preprocessed using the ML models to distinguish the faces based on the respective hair. This may include, for example, the at least one processor 120 of the electronic device 101 performing the preprocessing operation 204, which may apply a well pretrained face segmentation model to get the hair segmentation mask, which may produce a dataset Hₕₐᵢᵣₛ 206 for hair from each image frame.

At block 606, an image frame including a subject having an input hair color can be obtained. This may include, for example, the at least one processor 120 of the electronic device 101 obtaining the image frame I_{face} 214, which may be an image frame of the dataset I_{faces} 202.

At block 608, a target hair color can be generated based on the input hair color This may include, for example, the at least one processor 120 of the electronic device 101 performing the target color generation operation 222 to generate the target hair color C_{target} 224 based on a hair color of the subject of the image frame I_{face} 214, as determined using a hair extraction operation 216.

At block 610, an augmented hair color can be generated based on the target hair color by applying a non-learning algorithm and a dictionary data structure to the input hair color. This may include, for example, the at least one processor 120 of the electronic device 101 performing the color augmentation operation 226 to generate the augmented hair color I_{new_hair} 228 by shifting the color of Iₕₐᵢᵣ 218 according to C_{target} 224 to generate an augmented hair color I_{new_hair} 228 using a dictionary, as described with respect to FIG. 3.

Although FIG. 6 illustrates one example of a method 600 for efficient human hair color augmentation for enriching a face image SR dataset, various changes may be made to FIG. 6. For example, while shown as a series of steps, various steps could overlap, occur in parallel, occur in a different order, or occur any number of times (including zero times).

It should be noted that the functions shown in or described with respect to the figures can be implemented in an electronic device 101 or other device(s) in any suitable manner. For example, in some embodiments, at least some of the functions shown in or described with respect to the figures can be implemented or supported using one or more software applications or other software instructions that are executed by the processor 120 of the electronic device 101 or other device(s). In other embodiments, at least some of the operations shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices in various embodiments.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processor of an electronic device, a plurality of face inputs and one or more machine-learning (ML) models based on one or more datasets comprising a plurality of faces with respective hair;
preprocessing, using the at least one processor, the face inputs using the ML models to distinguish faces based on the respective hair;
obtaining, using the at least one processor, an image frame including a subject having an input hair color;
generating, using the at least one processor, a target hair color based on the input hair color; and
generating, using the at least one processor, an augmented hair color based on the target hair color by applying a non-learning algorithm and a dictionary data structure to the input hair color.

2. The method of claim 1, wherein the target hair color is an appropriate hair color that is provided as one of one or more candidate colors to improve visual quality of the input hair color.

3. The method of claim 1, further comprising:
extracting the input hair color from the subject of the obtained image frame by dividing the subject into a hair region and a non-hair region; and
combining the augmented hair color with the non-hair region to generate an augmented image frame.

4. The method of claim 3, further comprising:
blending a plurality of image frames to eliminate edges between the hair region having the augmented hair color and the non-hair region having skin of the subject,
wherein the augmented image frame is one of the plurality of image frames.

5. The method of claim 1, wherein preprocessing further comprises:
generating one or more categories of hair color based on the one or more datasets; and
training the one or more ML models based on the categories.

6. The method of claim 5, wherein the target hair color is generated by:
categorizing the input hair color based on the one or more categories; and
applying the ML model that corresponds to the categorized input hair color.

7. The method of claim 6, wherein categorizing further comprises:
filtering at least one hair color;
excluding the at least one filtered hair color in at least one category; and
clustering unexcluded hair colors into at least one other category.

8. An electronic device comprising:
at least one processing device configured to:
obtain a plurality of face inputs and one or more machine-learning (ML) models based on one or more datasets comprising a plurality of faces with respective hair;
preprocess the face inputs using the ML models to distinguish faces based on the respective hair;
obtain an image frame including a subject having an input hair color;
generate a target hair color based on the input hair color; and
generate an augmented hair color based on the target hair color by applying a non-learning algorithm and a dictionary data structure to the input hair color.

9. The electronic device of claim 8, wherein the target hair color is an appropriate hair color that is provided as one of one or more candidate colors to improve visual quality of the input hair color.

10. The electronic device of claim 8, wherein the at least one processing device is further configured to:
extract the input hair color from the subject of the obtained image frame by dividing the subject into a hair region and a non-hair region; and
combine the augmented hair color with the non-hair region to generate an augmented image frame.

11. The electronic device of claim 10, wherein the at least one processing device is further configured to:
blend a plurality of image frames to eliminate edges between the hair region having the augmented hair color and the non-hair region having skin of the subject, and
wherein the augmented image frame is one of the plurality of image frames.

12. The electronic device of claim 8, wherein to preprocess the face inputs using the ML models, the at least one processing device is further configured to:
generate one or more categories of hair color based on the one or more datasets; and
train the one or more ML models based on the categories.

13. The electronic device of claim 12, wherein to generate the target hair color based on the input hair color, the at least one processing device is further configured to:
categorize the input hair color based on the one or more categories; and
apply the ML model that corresponds to the categorized input hair color.

14. The electronic device of claim 13, wherein to categorize the input hair color, the at least one processing device is further configured to:
filter at least one hair color;
exclude the at least one filtered hair color in at least one category; and
cluster unexcluded hair colors into at least one other category.

15. A non-transitory machine readable medium containing instructions that when executed cause at least one processor of an electronic device to:
obtain a plurality of face inputs and one or more machine-learning (ML) models based on one or more datasets comprising a plurality of faces with respective hair;
preprocess the face inputs using the ML models to distinguish faces based on the respective hair;
obtain an image frame including a subject having an input hair color;
generate a target hair color based on the input hair color; and
generate an augmented hair color based on the target hair color by applying a non-learning algorithm and a dictionary data structure to the input hair color.

16. The non-transitory machine readable medium of claim 15, further containing instructions that when executed cause the at least one processor to:
extract the input hair color from the subject of the obtained image frame by dividing the subject into a hair region and a non-hair region; and
combine the augmented hair color with the non-hair region to generate an augmented image frame,
wherein the target hair color is an appropriate hair color that is provided as one of one or more candidate colors to improve visual quality of the input hair color.

17. The non-transitory machine readable medium of claim 16, further containing instructions that when executed cause the at least one processor to:
blend a plurality of image frames to eliminate edges between the hair region having the augmented hair color and the non-hair region having skin of the subject, and
wherein the augmented image frame is one of the plurality of image frames.

18. The non-transitory machine readable medium of claim 15, wherein to preprocess the face inputs using the ML models, the instructions, when executed, further cause the at least one processor to:
generate one or more categories of hair color based on the one or more datasets; and
train the one or more ML models based on the categories.

19. The non-transitory machine readable medium of claim 18, wherein to generate the target hair color based on the input hair color, the instructions, when executed, further cause the at least one processor to:
categorize the input hair color based on the one or more categories; and
apply the ML model that corresponds to the categorized input hair color.

20. The non-transitory machine readable medium of claim 15, wherein to categorize the input hair color, the at least one processor is further configured to:
filter at least one hair color;
exclude the at least one filtered hair color in at least one category; and
cluster unexcluded hair colors into at least one other category.
